(19) United States
(12) Patent Application Publication
(10) Pub. No.: US 2008/0113318 A1
(43) Pub. Date: May 15, 2008

(54) Mounted fabric/trim samples

(76) Inventors: Joe Veltri, East Dundee, IL (US); Gary Dobson, Arlington, TX (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/598,595

(22) Filed: Nov. 13, 2006

(51) Int. Cl. G09B 19/20; B42D 15/00; B42D 3/00; B42D 13/00

(52) U.S. Cl. 434/95; 283/56; 281/29; 281/38

(57) ABSTRACT

A substantially transparent display sheet for mounting of fabric and trim samples is provided which allows one to easily view the samples directly against various furniture and fabrics to determine color coordination. The samples are mounted on the display sheet so as to provide sufficient free space adjacent each of the samples to permit the fabric/furniture to be easily viewed through the sheet. A sample book is also provided which includes a front and back cover, and plurality of stacked display sheets bound therebetween.

### BACKGROUND OF THE INVENTION

The present invention relates to mounted fabric and/or trim samples, and more particularly, to such samples which are mounted onto a substantially transparent sheet which allow the sheets to be placed over a variety of different furniture or fabrics for the purpose of viewing the furniture/fabrics in conjunction with the samples.

Various types of display boards or binders have been developed for use in carrying or displaying samples of fabric or fabric trim such as tassels, cords, and the like. Such fabric/trim samples are typically mounted on a board such as heavy card stock and multiple boards containing the mounted samples may be stacked and retained in a binder. However, while such boards provide support to the fabric samples and allow the samples to be easily displayed and viewed, because the samples are typically permanently mounted to the board, it is difficult to compare the mounted fabric samples with other pieces of fabric or furniture for the purposes of determining, for example, whether the fabric/furniture colors coordinate. While it is possible to bind individual samples of fabric in a book in a manner which allows them to be removed, such fabric samples are more susceptible to damage and wear over time, such as fraying at the edges. In addition, it is not practical to display fabric trim such as cords in such a manner unless it is mounted on a support.

It would be desirable to be able to easily view fabric and trim samples for the purposes of matching such samples to fabrics and furniture without the drawbacks of prior mounted samples. Accordingly, there is still a need in the art for an improved method of mounting fabric and trim samples which allow one to easily view the samples directly against various furniture and fabrics without removal of the samples from a mounted sheet and without damaging the fabric trim pieces.

### SUMMARY OF THE INVENTION

The present invention meets that need by providing a substantially transparent display sheet for the mounting of fabric and trim samples which allows one to easily view the samples directly against various furniture and fabrics without removal of the samples and without damaging the fabric trim pieces.

According to one aspect of the present invention, a display sheet for samples of fabric and/or trim is provided comprising a substantially transparent sheet having first and second surfaces and first and second side edges, and a plurality of samples of fabric and/or trim mounted on the first surface of the transparent sheet. The samples are positioned on the sheet such that there is sufficient free space adjacent each of the samples to permit selected fabric or furniture to be viewed through the transparent sheet in conjunction with one or more of the samples.

The samples may be mounted on the sheet with an adhesive. Alternatively, the samples may be mounted on the sheet by stitching the samples to the sheet.

In one embodiment, the display sheet may further include a support adhered to the second surface of the transparent sheet along at least a portion of the first side edge.

The display sheet may further include a reinforcing strip adhered to the first surface of the transparent sheet along at least a portion of the first side edge. The reinforcing strip is preferred for use where the display sheet is assembled in a binder for use.

The substantially transparent display sheet preferably comprises a polymeric film such as poly(vinyl chloride). The sheet may be flexible or stiff, depending on the desired use.

In another embodiment of the invention, a plurality of display sheets are assembled in a stack and provided in a sample book which may comprise, for example, a binder. The sample book preferably comprises a front cover, a back cover, and a plurality of display sheets for fabric and/or trim samples bound therebetween.

In this embodiment, each of the display sheets preferably includes a support, where the second surface of the transparent sheet is adhered to the support along at least a portion of the first side edge. The display sheets also preferably include a reinforcing strip adhered to the first surface of the transparent sheet along at least a portion of the first side edge.

Where the sample book is in the form of a binder, each of the display sheets are preferably provided with at least one hole in the side edge which extends through the reinforcing strip, the transparent sheet, and the support to permit the display sheets to be bound in the book. Preferably, the display sheets are also removable from the book.

Preferably, the sample book includes front and back covers having inner and outer surfaces and a binding device. The inner surface of the front and/or back covers may include printed indicia thereon.

In another embodiment of the sample book, the display sheet may comprise a first display sheet, a second display sheet, and a support, where the support is positioned between the first display sheet and the second display sheet and is adhered to the sheets along at least a portion of a first side edge thereof. In this embodiment, fabric and/or trim samples may be provided on both the first and second display sheets.

In another embodiment of the sample book, one or more additional sheets are provided which may be overlaid on the display sheet. The additional sheet or sheets are preferably substantially transparent and may include printed indicia thereon. The sheet may also be of a different shape or size than the display sheet, and may include samples of fabric or trim mounted thereon to permit easy viewing for purposes of coordinating the colors of fabrics and/or trim pieces.

Accordingly, it is a feature of the present invention to provide a substantially transparent display sheet for the mounting of fabric and trim samples which allows the samples to be viewed directly against various furniture and fabrics. It is another feature of the present invention to provide a sample book containing a plurality of display sheets. Other features and advantages of the invention will be apparent from the following description, the accompanying drawings, and the appended claims.

### BRIEF DESCRIPTION OF THE DRAWINGS

FIG. 1 is a perspective view of an embodiment of a display sheet containing fabric and trim samples thereon;

FIG. 2 is a perspective view of a display sheet adhered to a support and including a reinforcing strip;

FIG. 3 is a perspective view of an embodiment illustrating first and second display sheets with a support therebetween;

FIG. 4 is a perspective view of a sample book containing a plurality of display sheets therein;

FIG. 5 is a perspective view illustrating the front cover of the sample book; and

FIG. 6 is a perspective view illustrating a display sheet including an additional overlay sheet.

### DETAILED DESCRIPTION OF THE PREFERRED EMBODIMENTS

The display sheet and sample book of the present invention provide an efficient way of mounting fabric and trim samples which allow a user to easily view the samples directly against various furniture and fabrics without having to remove the samples and without damaging the samples.

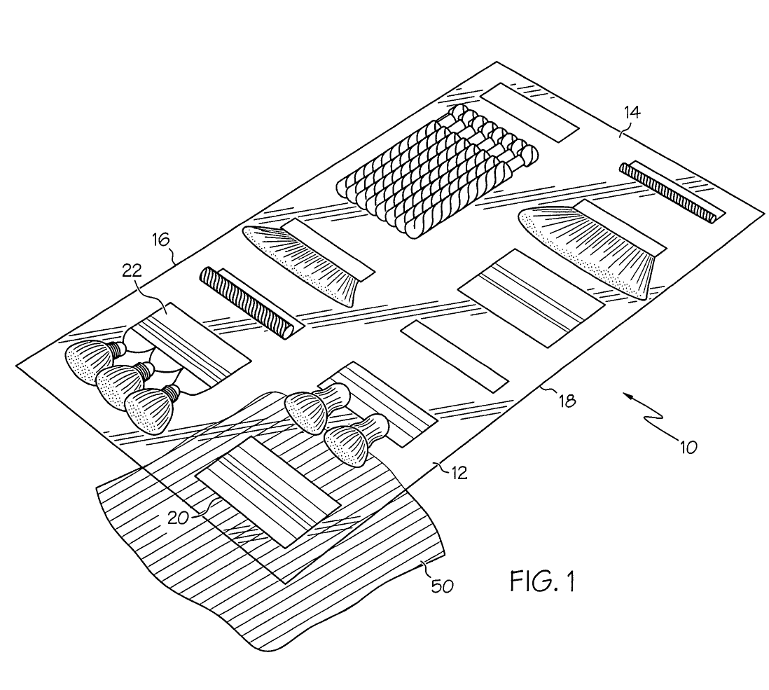

Referring now to FIG. 1, a display sheet 10 is shown which comprises a substantially transparent sheet 12 having a first surface 14 and first and second side edges 16 and 18. The substantially transparent display sheet preferably comprises a polymeric film such as poly(vinyl chloride). Suitable polyvinyl chloride films are commercially available from a number of sources including Sommers Plastics, Clifton, N.J., and Global Plastics, Brooklyn, N.Y.

The sheet may be flexible or stiff, depending on the desired form for use.

As shown, a plurality of samples of fabric 20 and trim 22 are mounted on the first surface 14 of the transparent sheet. As shown, the samples are positioned on the sheet such that there is sufficient free space adjacent each of the samples to permit selected fabric or furniture to be viewed through the transparent sheet.

The samples may be mounted on the sheet with an adhesive (not shown) or alternatively, the samples may be mounted on the sheet by stitching the samples to the sheet (not shown).

Also as shown in FIG. 1, a fabric sample 50 may be easily placed underneath the display sheet 10 and viewed through the sheet in conjunction with one of the fabric samples 20 on the sheet for purpose of determining fabric coordination.

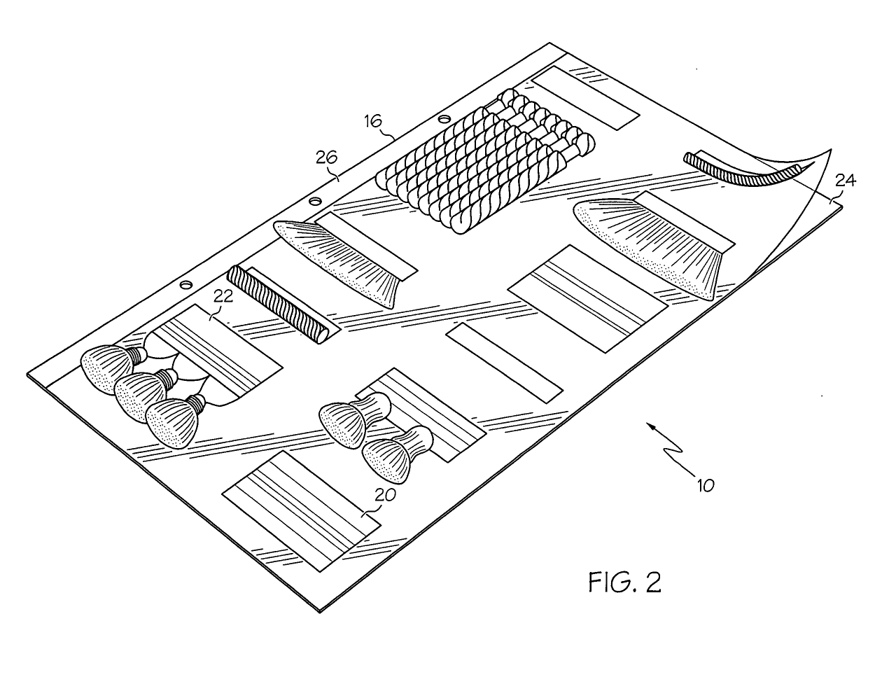

Referring now to FIG. 2, the display sheet preferably further includes a support 24 adhered to the second surface of the transparent sheet along at least a portion of the first side edge 16. The support may comprise card stock, or any other material which provides structural support to the transparent sheet.

The display sheet also preferably includes a reinforcing strip 26 adhered to said first surface of the transparent sheet along at least a portion of the first side edge 16. The reinforcing strip is preferred for use where the display sheet is assembled in a binder for use.

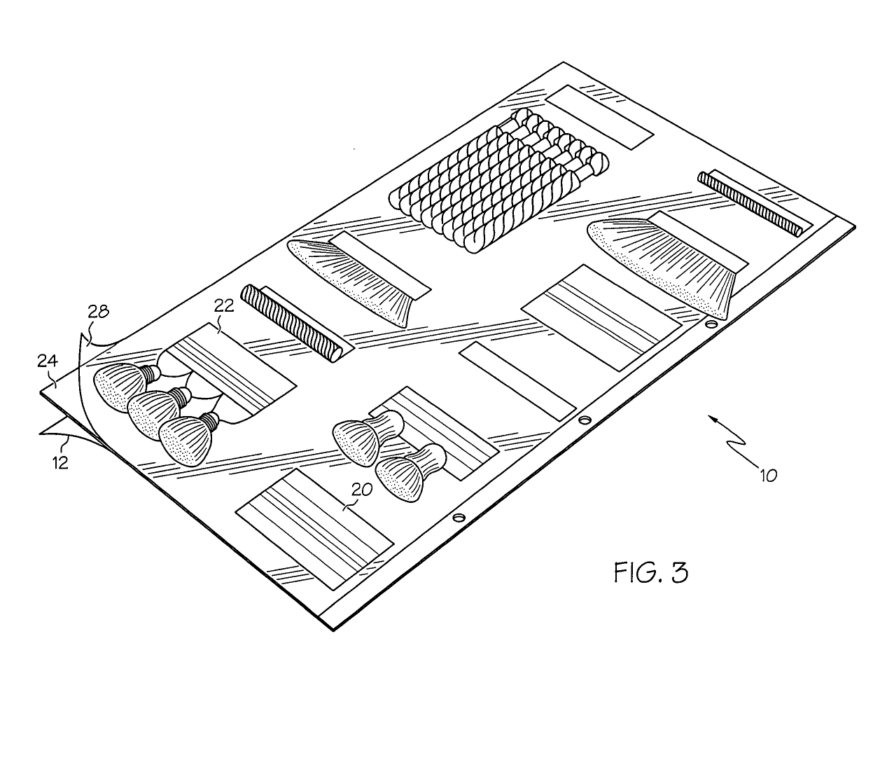

FIG. 3 illustrates yet another embodiment of the invention in which the display sheet comprises a first display sheet 12, a support 24, and a second display sheet 28. In this embodiment, the first surfaces of the transparent sheets preferably include fabric and/or trim samples thereon.

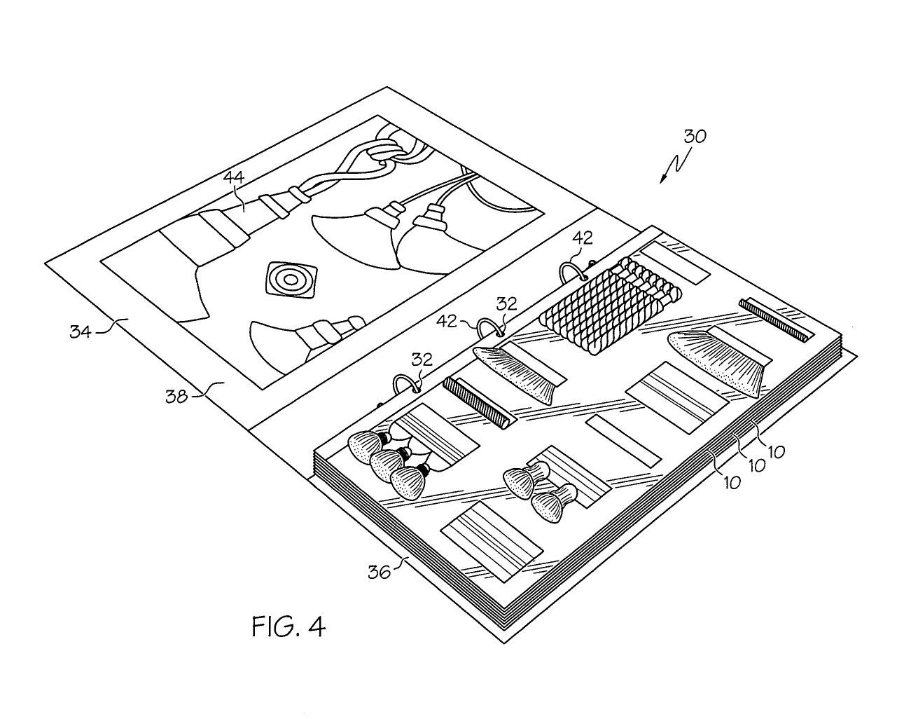

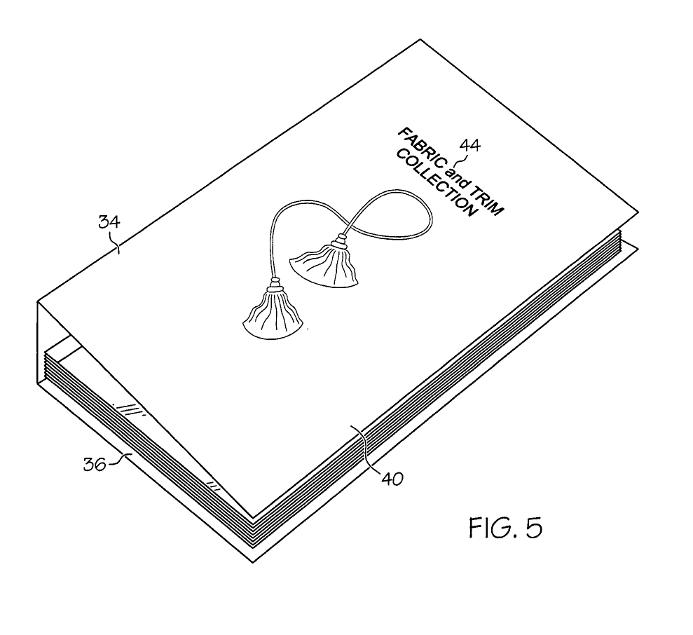

Referring now to FIGS. 4 and 5, a sample book 30 is shown which includes a plurality of display sheets 10 which are assembled in a stack and bound as shown. As shown, where the sample book comprises a binder, each of the display sheets are preferably provided with one or more holes 32 along the side edge which extends through the reinforcing strip, the transparent sheet, and the support to permit the display sheets to be bound in the book. This also allows the display sheets to be removable from the book.

As shown in FIGS. 4 and 5, the sample book includes front and back covers 34, 36 having inner and outer surfaces 38, 40 and a binding device 42. The inner and/or outer surfaces of the front and/or back covers may include printed indicia and/or graphics 44 thereon.

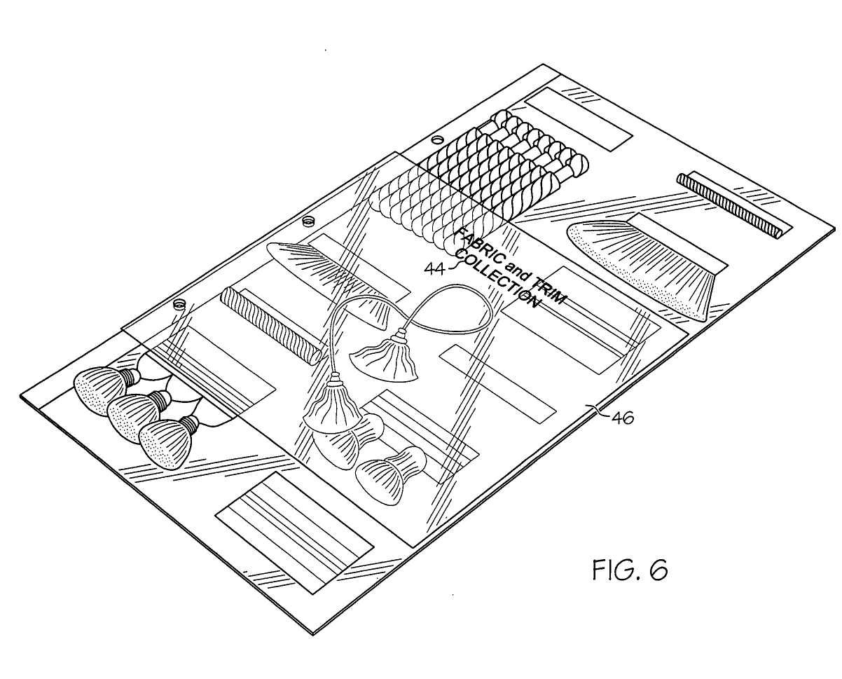

Referring now to FIG. 6, another embodiment of the invention is shown in which the display sheet includes at least one additional sheet 46 which is overlaid on the display sheet. The additional sheet is preferably substantially transparent and may include printed indicia 44 thereon including graphs of other fabric and/or trims to enable easy viewing for purposes of coordinating colors of various fabrics and/or trims. The sheet may be of a different shape or size than the display sheet as shown. The additional sheet may also include samples of fabric or trim mounted thereon (not shown).

It will be apparent to those skilled in the art that various changes may be made without departing from the scope of the invention which is not considered limited to what is described in the specification.

What is claimed is:

1. A display sheet for samples of fabric and/or trim comprising:
a substantially transparent sheet having first and second surfaces and first and second side edges;
a plurality of samples or fabric and/or trim mounted on said first surface of said transparent sheet; wherein said samples are positioned on said sheet such that there is sufficient free space adjacent each of said samples to permit selected fabric or furniture to be viewed through said transparent sheet in conjunction with one or more of said samples.

2. The display sheet of claim 1 wherein said samples are mounted on said sheet with an adhesive.

3. The display sheet of claim 1 wherein said samples are mounted on said sheet by stitching said samples to said sheet.

4. The display sheet of claim 1 further including a support adhered to said second surface of said transparent sheet along at least a portion of said first side edge.

5. The display sheet of claim 4 including a reinforcing strip adhered to said first surface of said transparent sheet along at least a portion of said first side edge.

6. The display sheet of claim 1 wherein said substantially transparent sheet comprises a polymeric film.

7. The display sheet of claim 6 wherein said polymeric film comprises poly(vinyl chloride).

8. The display sheet of claim 1 wherein said transparent sheet is flexible.

9. The display sheet of claim 1 wherein said transparent sheet is stiff.

10. A sample book comprising a stack of a plurality of display sheets for fabric and/or trim samples, wherein each of said display sheets comprises:
a substantially transparent sheet having first and second surfaces and first and second side edges; and
a plurality of samples of fabric and/or trim mounted on said first surface of said transparent sheet; wherein said samples are positioned on said sheet such that there is sufficient free space adjacent each of said samples to permit selected fabric or furniture to be viewed through said transparent sheet in conjunction with one or more of said samples.

11. The sample book of claim 10 wherein each of said display sheets further includes a support; and wherein said second surface of said transparent sheet is adhered to said support along at least a portion of said first side edge.

12. The sample book of claim 11 wherein each of said display sheets further includes a reinforcing strip adhered to said first surface of said transparent sheet along at least a portion of said first side edge.

13. The sample book of claim 12 including at least one hole in said side edge of each of said display sheets which extends through said reinforcing strip, said transparent sheet, and said support to permit said display sheets to be bound in said book.

14. The sample book of claim 10 including front and back covers having inner and outer surfaces and a binding device.

15. The sample book of claim 14 wherein said inner surface of said front and/or back covers includes printed indicia thereon.

16. The sample book of claim 14 wherein said outer surface of said front and/or back covers includes printed indicia thereon.

17. The sample book of claim 10 wherein said display sheets are removable from said book.

18. The sample book of claim 10 wherein said display sheet comprises a first display sheet, a second display sheet, and a support; wherein said support is positioned between said first display sheet and said second display sheet and is adhered to said sheets along at least a portion of a first side edge thereof.

19. The sample book of claim 10 further including at least one additional sheet which is overlaid on said display sheet.

20. The sample book of claim 19 wherein said at least one additional sheet is substantially transparent.

21. The sample book of claim 19 wherein said at least one additional sheet includes printed indicia thereon.

22. The sample book of claim 19 wherein said at least one additional sheet includes samples of fabric or trim mounted thereon.

23. The sample book of claim 19 wherein said at least one additional sheet is of a different size or shape than said display sheet.

24. A sample book comprising a front cover, a back cover, and a plurality of display sheets for fabric and/or trim samples bound therebetween, wherein each of said display sheets comprises:
a substantially transparent sheet having first and second surfaces and first and second side edges; and
a plurality of samples of fabric and/or trim mounted on said first surface of said transparent sheet; wherein said samples are positioned on said sheet such that there is sufficient free space adjacent each of said samples to permit selected fabric or furniture to be viewed through said transparent sheet in conjunction with one or more of said samples.
